(19) United States
(12) Patent Application Publication
(10) Pub. No.: US 2023/0145477 A1
(43) Pub. Date: May 11, 2023

(54) HEATER ASSEMBLY AND AEROSOL GENERATING APPARATUS HAVING THE SAME

(71) Applicant: KT&G CORPORATION, Daejeon (KR)

(72) Inventors: Dong Sung KIM, Seoul (KR); Heon Jun JEONG, Seoul (KR); Won Kyeong LEE, Gyeonggi-do (KR); Jae Sung CHOI, Gyeonggi-do (KR)

(73) Assignee: KT&G CORPORATION, Daejeon (KR)

(21) Appl. No.: 17/775,342

(22) PCT Filed: Nov. 18, 2021
(86) PCT No.: PCT/KR2021/017022

§ 371 Date: May 9, 2022

(30) Foreign Application Priority Data
Nov. 20, 2020 (KR) 10-2020-0156919

(51) Int. Cl. H05B 3/48; A24F 40/46

(52) U.S. Cl. CPC H05B 3/48; A24F 40/46; H05B 2203/002; H05B 2203/016; H05B 2203/011

(57) ABSTRACT

A heater assembly includes a heating element formed in a mesh having a tubular shape, and configured to generate heat when electricity is supplied, and a plurality of electrodes respectively connected to opposite end portions the heating element in a lengthwise direction, extending in a circumferential direction of the heating element, and configured to supply the electricity to the heating element.

### TECHNICAL FIELD

One or more embodiments of the disclosure relate to a heater assembly and an aerosol-generating apparatus including the same, and more particularly, to a heating assembly having improved heating performance and an aerosol-generating apparatus including the heating assembly.

### BACKGROUND ART

Recently, there is growing demand for an alternative to traditional combustive cigarettes. For example, research has been conducted on a method of providing an aerosol by heating an aerosol generating material in a liquid or solid state, or generating an aerosol by heating an aerosol generating material and then passing the generated aerosol through an aroma medium.

In an aerosol-generating apparatus for generating an aerosol by heating an aerosol-generating article (e.g., a cigarette), a heater assembly for generating heat from electricity may be used. In general, the heater assembly includes electrodes that supply electricity to a heating element for generating heat from electricity, and when the electrodes contact each other, a short circuit may be generated. To prevent such short circuit, a heating element for surrounding a cigarette may be designed such that both ends do not contact each other.

In this case, however, some portions of an aerosol-generating article are not completely surrounded by the heating element, and thus the heating element may not sufficiently heat the aerosol-generating article, resulting in an insufficient amount of the aerosol.

As a new structure for the heater assembly of an aerosol-generating apparatus, a heating element using circuit patterns arranged on a surface of an insulating substrate is also being considered. In the heating element using the circuit patterns, the circuit patterns generates heat when electricity is supplied. In the circuit patterns, gaps between circuit patterns have to be sufficiently secured to prevent the short circuit. Therefore, there is a limitation to aerosol generation because heat may be insufficiently delivered to some portions of the aerosol-generating article that correspond to the gaps between the circuit patterns, when the circuit pattern surrounding the aerosol-generating article heats the aerosol-generating article.

### DISCLOSURE OF INVENTION

### Technical Problem

One or more embodiments provide a heater assembly capable of generating a high-quality aerosol and an aerosol-generating apparatus including the same.

One or more embodiments also provide a heater assembly that uniformly and effectively heats the entire aerosol-generating article, and an aerosol-generating apparatus including the heating assembly.

### Solution to Problem

According to an embodiment, a heater assembly includes a heating element formed in a mesh having a tubular shape, and configured to generate heat when electricity is supplied; and a plurality of electrodes respectively connected to opposite end portions of the heating element in a lengthwise direction, extending in a circumferential direction of the heating element, and configured to supply the electricity to the heating element.

### Advantageous Effects of Invention

According to the one or more embodiments, in a heater assembly and an aerosol-generating apparatus including the same, electrodes are arranged to extend in a circumferential direction of a heating element, and thus the heating element may uniformly heat the entire aerosol-generating article. Thus, the heating performance of the heating assembly may be improved, and a high-quality aerosol may be generated by uniformly heating the aerosol-generating article.

### BRIEF DESCRIPTION OF DRAWINGS

FIGS. 1 and 2 are diagrams showing examples in which an aerosol generating article is inserted into an aerosol generating device.

FIG. 3 is a drawing illustrating an example of a cigarette.

FIG. 4 is a flowchart of operations of a method of manufacturing a heating assembly of an aerosol-generating apparatus, according to an embodiment.

FIG. 5A is a schematic conceptual view of some operations of the method of manufacturing a heater assembly of an aerosol-generating apparatus, according to the embodiment of FIG. 4.

FIG. 5B is a schematic conceptual view of other operations of the method of manufacturing a heater assembly of an aerosol-generating apparatus, according to the embodiment of FIG. 4.

FIGS. 6 and 7 are schematic conceptual views of other operations of the method of manufacturing a heater assembly of an aerosol-generating apparatus, according to the embodiment of FIG. 4.

FIG. 8 is a cross-sectional view of an example in which the heater assembly of the aerosol-generating apparatus of FIGS. 4 to 7 is used.

FIG. 9 is a cross-sectional view of a heater assembly of an aerosol-generating apparatus, according to another embodiment.

FIG. 10 is a perspective view of a heater assembly of an aerosol-generating apparatus, according to another embodiment.

FIG. 11 is a cross-sectional view of the heater assembly of an aerosol-generating apparatus, according to the embodiment of FIG. 10.

FIG. 12 is a perspective view of a heater assembly of an aerosol-generating apparatus, according to another embodiment.

FIG. 13 is a cross-sectional view of a heater assembly of an aerosol-generating apparatus, according to another embodiment.

FIG. 14 is a cross-sectional view of a heater assembly of an aerosol-generating apparatus, according to another embodiment.

FIG. 15 is a schematic cross-sectional view of a portion of an aerosol-generating apparatus, according to another embodiment.

FIG. 16 is a schematic diagram illustrating a connection between a heater assembly and other components of an aerosol-generating apparatus according to an embodiment.

FIG. 17 is a schematic diagram illustrating a connection between the heater assembly and other components of an aerosol-generating apparatus according to another embodiment.

FIG. 18 is a schematic diagram illustrating a connection between the heater assembly and other components of an aerosol-generating apparatus according to another embodiment.

FIG. 19 is a schematic diagram illustrating a connection between the heater assembly and other components of an aerosol-generating apparatus according to another embodiment.

FIG. 20 is a perspective view of a heater assembly of an aerosol-generating apparatus, according to another embodiment.

### BEST MODE FOR CARRYING OUT THE INVENTION

With respect to the terms used to describe in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

If one component or layer is mentioned to be “over,” “above,” “connected to,” or “combined with” another component or layer, the one component or layer is arranged to be over, above, connected to, or combined with the other component or layer with or without an intervening component(s) or layer(s). In contrast, if one component or layer is mentioned to be “directly over,” “directly above,” “directly connected to,” or “directly combined with” another component or layer, there is no additional components or layers between the components or layers. In the disclosure, the same reference numbers may indicate the same components.

Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein.

In the present disclosure, ‘embodiments’ are distinguished from each other only for the purpose of explanation, the embodiments should not be construed to be exclusive. For example, some features in one embodiment may be applied to and implemented in other embodiment in the scope of the spirit described in the present disclosure.

In addition, terms used in the present specification are for describing the embodiments and are not intended to limit the embodiments. In the present specification, the singular form also includes the plurality form unless specifically stated in the phrase.

While such terms as “first,” “second,” etc. may be used to describe various components, such components must not be limited to the above terms. The above terms are used only to distinguish one component from another.

Throughout the specification, the “longitudinal direction” of a component may be a lengthwise direction in which a longitudinal axis of the component extends.

According to an embodiment, a heater assembly includes a heating element formed in a mesh having a tubular shape, and configured to generate heat when electricity is supplied; and a plurality of electrodes respectively connected to opposite end portions of the heating element in a lengthwise direction, extending in a circumferential direction of the heating element, and configured to supply the electricity to the heating element.

The plurality of electrodes may include a first electrode arranged at an upper end portion of the heating element and a second electrode arranged at a lower end portion of the heater element, and the first electrode and the second electrode may extend along an entire circumference of the heating element.

The first electrode may be arranged on an inner side or an outer side of the heating element, and the second electrode may be arranged on the inner side or the outer side of the heating element.

The heater assembly may further include a support arranged on an inner side of the heating element and including a material that transmits heat.

The heater assembly may further include a support arranged on an outer side of the heating element and including a material that blocks heat.

The plurality of electrodes may include a first electrode arranged at an upper end portion of the heating element, and a second electrode arranged at a lower end portion of the heating element, and the first electrode and the second electrode may extend from an inner side of the heating element to an outer side of the support.

The heating element may extend from an inner side of the support to an outer side of the support such that the opposite end portions of the heating element are arranged on the outer side of the support, and the plurality of electrodes may be respectively connected to the opposite end portions of the heating element arranged on the outer side of the support.

The heater assembly may further include a protective film arranged on at least one of an inner side and an outer side of the heating element.

Opposite edges of the heating element in a circumferential direction of the heating element may contact each other.

Opposite end portions of the heating element in a circumferential direction of the heating element may overlap each other.

The plurality of electrodes may respectively include a plurality of terminals protruding outwards from the heating element.

According to another embodiment, an aerosol-generating apparatus includes the heater assembly, which includes a heating element formed in a mesh having a tubular shape, and configured to generate heat when electricity is supplied; and a plurality of electrodes respectively connected to opposite end portions of the heating element in a lengthwise direction, extending in a circumferential direction of the heating element, and configured to supply the electricity to the heating element, and an electricity supply unit configured to supply electricity to the heater assembly.

### MODE FOR THE INVENTION

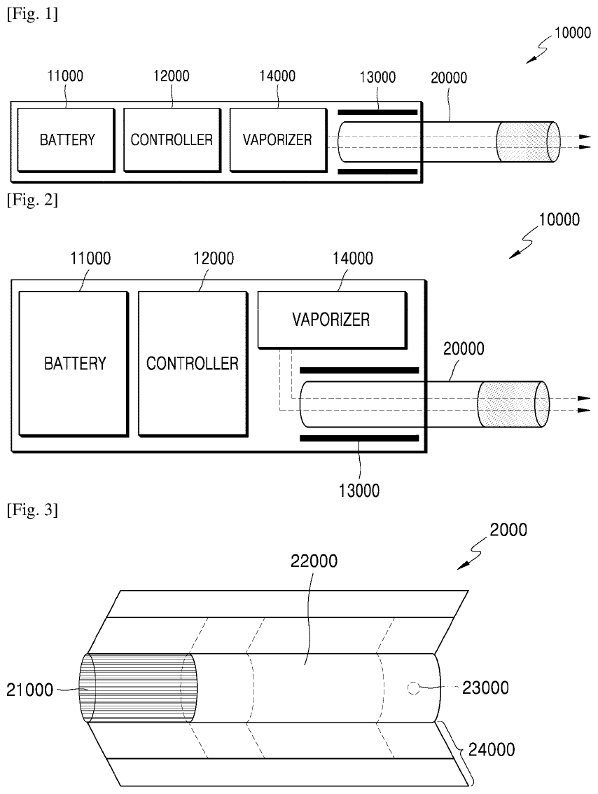

FIGS. 1 and 2 are diagrams showing examples in which a cigarette is inserted into an aerosol generating device.

Referring to FIGS. 1 and 2, an aerosol generating device 100 includes a battery 11000, a controller 12000, a heater 13000, and a vaporizer 14000. Also, a cigarette 20000 may be inserted into an inner space of the aerosol generating device 10000.

The aerosol generating device 10000 illustrated in FIGS. 1 and 2 includes the vaporizer. However, the embodiments are not limited to the implementation method thereof, and the vaporizer may be omitted. In case the vaporizer is omitted from the aerosol generating device 10000, the aerosol generating article 20000 contains an aerosol generating material, so that the aerosol generating article 20000 generates aerosol when the aerosol generating article 20000 is heated by the heater 13000.

FIGS. 1 and 2 illustrate only components of the aerosol generating device 10000, which are related to the present embodiment. Therefore, it will be understood by one of ordinary skill in the art related to the present embodiment that other general-purpose components may be further included in the aerosol generating device 10000, in addition to the components illustrated in FIG. 1.

Also, FIGS. 1 and 2 illustrate that the aerosol generating device 10000 includes the heater 13000. However, according to embodiments, the heater 13000 may be omitted.

FIG. 1 illustrates that the battery 11000, the controller 12000, the vaporizer 14000, and the heater 13000 are arranged in series. Also, FIG. 2 illustrates that the vaporizer 14000 and the heater 13000 are arranged in parallel. However, the internal structure of the aerosol generating device 10000 is not limited to the structures illustrated in FIG. 1 or FIG. 2. In other words, according to the design of the aerosol generating device 10000, the battery 11000, the controller 12000, the vaporizer 14000, and the heater 13000 may be differently arranged.

When the cigarette 20000 is inserted into the aerosol generating device 10000, the aerosol generating device 10000 may operate the vaporizer 14000 to generate aerosol from the vaporizer 14000. The aerosol generated by the vaporizer 14000 is delivered to the user by passing through the cigarette 20000. The vaporizer 14000 will be described in more detail later.

The battery 11000 may supply power to be used for the aerosol generating device 10000 to operate. For example, the battery 11000 may supply power to heat the heater 13000 or the vaporizer 14000, and may supply power for operating the controller 12000. Also, the battery 1100000 may supply power for operations of a display, a sensor, a motor, etc. mounted in the aerosol generating device 10000.

The controller 12000 may generally control operations of the aerosol generating device 10000. In detail, the controller 12000 may control not only operations of the battery 1100000, the heater 13000, and the vaporizer 14000, but also operations of other components included in the aerosol generating device 10000. Also, the controller 12000 may check a state of each of the components of the aerosol generating device 10000 to determine whether or not the aerosol generating device 10000 is able to operate.

The controller 12000 may include at least one processor. A processor can be implemented as an array of a plurality of logic gates or can be implemented as a combination of a general-purpose microprocessor and a memory in which a program executable in the microprocessor is stored. It will be understood by one of ordinary skill in the art that the processor can be implemented in other forms of hardware.

The heater 13000 may be heated by the power supplied from the battery 11000. For example, when the cigarette 20000 is inserted into the aerosol generating device 10000, the heater 13000 may be located outside the cigarette 20000. Thus, the heated heater 13000 may increase a temperature of an aerosol generating material in the aerosol generating article 2000.

The heater 13000 may include an electro-resistive heater. For example, the heater 13000 may include an electrically conductive track, and the heater 13000 may be heated when currents flow through the electrically conductive track. However, the heater 13000 is not limited to the example described above and may include any other heaters which may be heated to a desired temperature. Here, the desired temperature may be pre-set in the aerosol generating device 10000 or may be set by a user.

As another example, the heater 13000 may include an induction heater. In detail, the heater 13000 may include an electrically conductive coil for heating a cigarette in an induction heating method, and the cigarette may include a susceptor which may be heated by the induction heater.

FIGS. 1 and 2 illustrate that the heater 13000 is positioned outside the cigarette 20000, but the position of the cigarette 20000 is not limited thereto. For example, the heater 13000 may include a tube-type heating element, a plate-type heating element, a needle-type heating element, or a rod-type heating element, and may heat the inside or the outside of the aerosol generating article 20000, according to the shape of the heating element.

Also, the aerosol generating device 10000 may include a plurality of heaters 13000. Here, the plurality of heaters 13000 may be inserted into the cigarette 20000 or may be arranged outside the cigarette 20000. Also, some of the plurality of heaters 13000 may be inserted into the cigarette 20000 and the others may be arranged outside the cigarette 20000. In addition, the shape of the heater 13000 is not limited to the shapes illustrated in FIGS. 1 and 2 and may include various shapes.

The vaporizer 14000 may generate aerosol by heating a liquid composition and the generated aerosol may pass through the aerosol generating article 20000 to be delivered to a user. In other words, the aerosol generated via the vaporizer 14000 may move along an air flow passage of the aerosol generating device 10000 and the air flow passage may be configured such that the aerosol generated via the vaporizer 14000 passes through the cigarette 20000 to be delivered to the user.

For example, the vaporizer 14000 may include a liquid storage, a liquid delivery element, and a heating element, but it is not limited thereto. For example, the liquid storage, the liquid delivery element, and the heating element may be included in the aerosol generating device 10000 as independent modules.

The liquid storage may store a liquid composition. For example, the liquid composition may be a liquid including a tobacco-containing material having a volatile tobacco flavor component, or a liquid including a non-tobacco material. The liquid storage may be formed to be detachable from the vaporizer 14000 or may be formed integrally with the vaporizer 14000.

For example, the liquid composition may include water, a solvent, ethanol, plant extract, spices, flavorings, or a vitamin mixture. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. Also, the liquid composition may include an aerosol forming substance, such as glycerin and propylene glycol.

The liquid delivery element may deliver the liquid composition of the liquid storage to the heating element. For example, the liquid delivery element may be a wick such as cotton fiber, ceramic fiber, glass fiber, or porous ceramic, but is not limited thereto.

The heating element is an element for heating the liquid composition delivered by the liquid delivery element. For example, the heating element may be a metal heating wire, a metal hot plate, a ceramic heater, or the like, but is not limited thereto. In addition, the heating element may include a conductive filament such as nichrome wire and may be positioned as being wound around the liquid delivery element. The heating element may be heated by a current supply and may transfer heat to the liquid composition in contact with the heating element, thereby heating the liquid composition. As a result, aerosol may be generated.

For example, the vaporizer 14000 may be referred to as a cartomizer or an atomizer, but it is not limited thereto.

The aerosol generating device 10000 may further include general-purpose components in addition to the battery 11000, the controller 12000, and the heater 13000. For example, the aerosol generating device 10000 may include a display capable of outputting visual information and/or a motor for outputting haptic information. Also, the aerosol generating device 10000 may include at least one sensor (e.g., a puff sensor, a temperature sensor, an aerosol generating article insertion detecting sensor, etc.). Also, the aerosol generating device 10000 may be formed as a structure that, even when the aerosol generating article 20000 is inserted into the aerosol generating device 10000, may introduce external air or discharge internal air.

Although not illustrated in FIGS. 1 and 2, the aerosol generating device 10000 and an additional cradle may form together a system. For example, the cradle may be used to charge the battery 11000 of the aerosol generating device 10000. Alternatively, the heater 13000 may be heated when the cradle and the aerosol generating device 10000 are coupled to each other.

The aerosol generating article 20000 may be similar to a general combustive cigarette. For example, the aerosol generating article 20000 may be divided into a first portion including an aerosol generating material and a second portion including a filter, etc. Alternatively, the second portion of the aerosol generating article 20000 may also include an aerosol generating material. For example, an aerosol generating material made in the form of granules or capsules may be inserted into the second portion.

The entire first portion may be inserted into the aerosol generating device 10000, and the second portion may be exposed to the outside. Alternatively, only a portion of the first portion may be inserted into the aerosol generating device 10000, or a portion of the first portion and a portion of the second portion may be inserted thereinto. The user may puff aerosol while holding the second portion by the mouth of the user. In this case, the aerosol is generated by the external air passing through the first portion, and the generated aerosol passes through the second portion and is delivered to the user's mouth.

For example, the external air may flow into at least one air passage formed in the aerosol generating device 10000. For example, opening and closing of the air passage and/or a size of the air passage formed in the aerosol generating device 10000 may be adjusted by the user. Accordingly, the amount of smoke and a smoking impression may be adjusted by the user. As another example, the external air may flow into the aerosol generating article 20000 through at least one hole formed in a surface of the aerosol generating article 20000.

Hereinafter, an example of the cigarette 20000 will be described with reference to FIG. 3.

FIG. 3 is a drawing illustrating an example of a cigarette.

Referring to FIG. 3, the cigarette 20000 may include a tobacco rod 21000 and a filter rod 22000. The first portion described above with reference to FIGS. 1 and 2 may include the tobacco rod 21000, and the second portion may include the filter rod 22000.

FIG. 3 illustrates that the filter rod 22000 includes a single segment. However, the filter rod 22000 is not limited thereto. In other words, the filter rod 22000 may include a plurality of segments. For example, the filter rod 22000 may include a first segment configured to cool an aerosol and a second segment configured to filter a certain component included in the aerosol. Also, as necessary, the filter rod 22000 may further include at least one segment configured to perform other functions.

The aerosol generating article 20000 may be packaged by at least one wrapper 24000. The wrapper 24000 may have at least one hole through which external air may be introduced or internal air may be discharged. For example, the cigarette 20000 may be packaged via one wrapper 24000. As another example, the aerosol generating article 20000 may be doubly packaged by two or more wrappers 24000. For example, the tobacco rod 21000 may be packaged by a first wrapper, and the filter rod 22000 may be packaged by wrappers. Also, the tobacco rod 21000 and the filter rod 22000, which are respectively packaged via separate wrappers, may be coupled to each other, and the entire cigarette 20000 may be packaged via a third wrapper. When the filter rod 22000 includes a plurality of segments, each segment may be packaged by wrappers. Also, the entire cigarette 20000 including the plurality of segments, which are respectively packaged via the separate wrappers and which are coupled to each other, may be repackaged via another wrapper.

The tobacco rod 21000 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 21000 may include other additives, such as flavors, a wetting agent, and/or organic acid. Also, the tobacco rod 21000 may include a flavored liquid, such as menthol or a moisturizer, which is injected to the tobacco rod 21000.

The tobacco rod 21000 may be manufactured in various forms. For example, the tobacco rod 21000 may be formed as a sheet or a strand. Also, the tobacco rod 21000 may be formed as a pipe tobacco, which is formed of tiny bits cut from a tobacco sheet. Also, the tobacco rod 21000 may be surrounded by a heat conductive material. For example, the heat-conducting material may be, but is not limited to, a metal foil such as aluminum foil. For example, the heat conductive material surrounding the tobacco rod 21000 may uniformly distribute heat transmitted to the tobacco rod 21000, and thus, the heat conductivity applied to the tobacco rod may be increased and taste of the tobacco may be improved. Also, the heat conductive material surrounding the tobacco rod 21000 may function as a susceptor heated by the induction heater. Here, although not illustrated in the drawings, the tobacco rod 21000 may further include an additional susceptor, in addition to the heat conductive material surrounding the tobacco rod 21000.

The filter rod 22000 may include a cellulose acetate filter. Shapes of the filter rod 22000 are not limited. For example, the filter rod 22000 may include a cylinder-type rod or a tube-type rod having a hollow inside. Also, the filter rod 22000 may include a recess-type rod. When the filter rod 22000 includes a plurality of segments, at least one of the plurality of segments may have a different shape.

The filter rod 22000 may be formed to generate flavors. For example, a flavoring liquid may be injected onto the filter rod 22000, or an additional fiber coated with a flavoring liquid may be inserted into the filter rod 22000.

Also, the filter rod 22000 may include at least one capsule 23000. Here, the capsule 23000 may generate a flavor or an aerosol. For example, the capsule 23000 may have a configuration in which a liquid containing a flavoring material is wrapped with a film. For example, the capsule 23000 may have a spherical or cylindrical shape, but is not limited thereto.

When the filter rod 22000 includes a segment configured to cool the aerosol, the cooling segment may include a polymer material or a biodegradable polymer material. For example, the cooling segment may include pure polylactic acid alone, but the material for forming the cooling segment is not limited thereto. In some embodiments, the cooling segment may include a cellulose acetate filter having a plurality of holes. However, the cooling segment is not limited to the above-described example and is not limited as long as the cooling segment cools the aerosol.

Although not illustrated in FIG. 3, the cigarette 20000 according to an embodiment may further include a front-end filter. The front-end filter may be arranged at one side of tobacco rod 21000 being opposite to the filter rod 2000. The front-end filter may prevent the tobacco rod 21000 from being detached outwards and prevent a liquefied aerosol from flowing into the aerosol generating device 10000 (FIGS. 1 and 2) from the tobacco rod 21000, during smoking.

Those of ordinary skill in the art related to the present embodiments may understand that various changes in form and details can be made therein without departing from the scope of the characteristics described above. The disclosed methods should be considered in a descriptive sense only and not for purposes of limitation. The scope of the present disclosure is defined by the appended claims rather than by the foregoing description, and all differences within the scope of equivalents thereof should be construed as being included in the present disclosure.

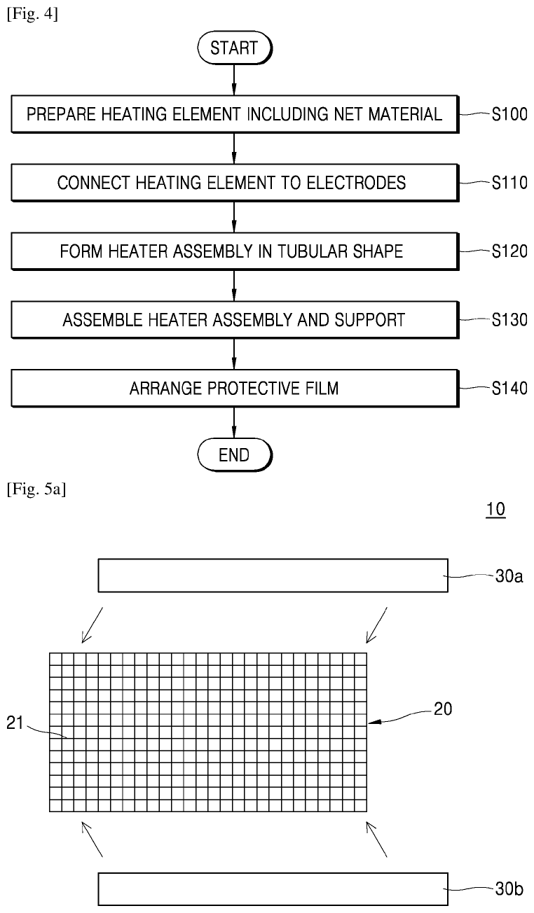

FIG. 4 is a flowchart of operations of a method of manufacturing a heating assembly of an aerosol-generating apparatus, according to an embodiment.

The method of manufacturing a heater assembly of an aerosol-generating apparatus according to the embodiment of FIG. 4 includes operation S100 of preparing a heating element formed in a mesh which is capable of generating heat when electricity is supplied, operation S110 of assembling the heater assembly by connecting the heating element to an electrode, operation S120 of forming the heater assembly in a tubular shape, operation S130 of assembling the heater assembly with a support, and operation S140 of arranging a protective film on at least one of an outer side and an inner side of the heater assembly.

Operation S110 of assembling the heater assembly by connecting the heating element to the electrode, operation S120 of forming the heater assembly in the tubular shape, and operation S130 of assembling the heater assembly with the support are not always performed sequentially. The above operations may be simultaneously performed or performed differently from the order shown in FIG. 4.

Also, operation S130 of assembling the heater assembly with the support and operation S140 of arranging the protective film are not essential operations and may be omitted according to embodiments.

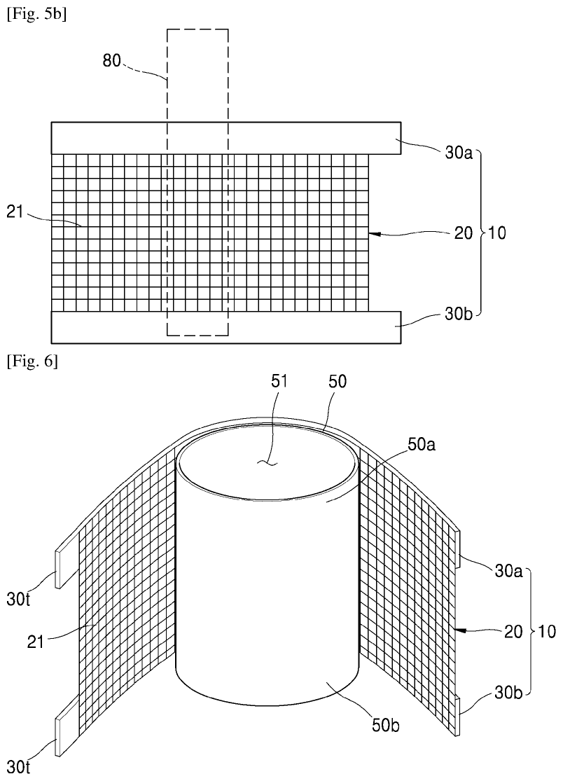

FIG. 5A is a schematic conceptual view of some operations of the method of manufacturing a heater assembly of an aerosol-generating apparatus, according to the embodiment of FIG. 4.

A heater assembly 10 of the aerosol-generating apparatus of FIG. 5A includes a heating element 20 formed in a mesh and generating heat when electricity is supplied, and electrodes 30a and 30b coupled to the heating element 20 and supplying the electricity to the heating element 20.

In order to manufacture the heater assembly 10, the heating element 20 formed in a mesh is prepared, which generates heat by electrical resistance when electricity is supplied. The heating element 20 includes a heating strand 21 including any one of metal (e.g., copper, stainless steel (SUS), or aluminum), metal alloy (e.g., nichrome), and a carbon heating material, or a combination thereof. The heating strand 21 may be a wire having a circular, oval, or flat prismatic cross-section.

The heating element 20 of FIG. 5A may include a plurality of heating strands 21 extending in a vertical direction, and a plurality of heating strands 21 extending in a horizontal direction, thereby forming a mesh shape including substantially square holes.

The heating element 20 having a mesh shape may be manufactured by weaving the heating strands 21, but embodiments are not limited thereto. For example, the heating element 20 may be manufactured in a manner that a plurality of holes are formed by removing a portion of a thin metal plate through an etching or drilling process.

The embodiments are not limited to square-shaped holes of the heating element 20, and shapes of the holes of the heating element 20 may vary. For example, the holes of the heating element 20 may have a polygon such as a triangle, a square, or a rectangle, a circle or an oval, and a honeycomb.

The electrodes 30a and 30b are electrically connected to the heating element 20 and perform a function of transmitting the electricity to the heating element 20. The electrodes 30a and 30b may each include any one of a metal material having high electrical conductivity such as copper, an alloy material having electrical conductivity, a carbon material, and a graphene material, or a combination thereof.

FIG. 5B is a schematic conceptual view of other operations of the method of manufacturing the heater assembly of the aerosol-generating apparatus, according to the embodiment of FIG. 4.

After the heater assembly 10 is assembled, an operation of forming the heater assembly 10 in a tubular shape is performed. When the heater assembly 10 is formed in the tubular shape, the heater assembly 10 is bent or folded to enable the heater assembly 10 to surround the aerosol-generating article 80 that is heated by the heater assembly 10. The aerosol-generating article 80 indicated by a dashed line is shown in FIG. 5B for convenience of description, and the aerosol-generating article 80 is not necessary when the heater assembly 10 is formed.

When the heater assembly 10 is formed in the tubular shape, the heater assembly 10 is bent or folded in a horizontal direction transverse to the longitudinal direction of the aerosol-generating article 80.

Therefore, in the heater assembly 10 is formed in the tubular shape, the first and second electrodes 30a and 30b may be respectively arranged at the upper portion and the lower portion and extend in a circumferential direction of the heating element 20.

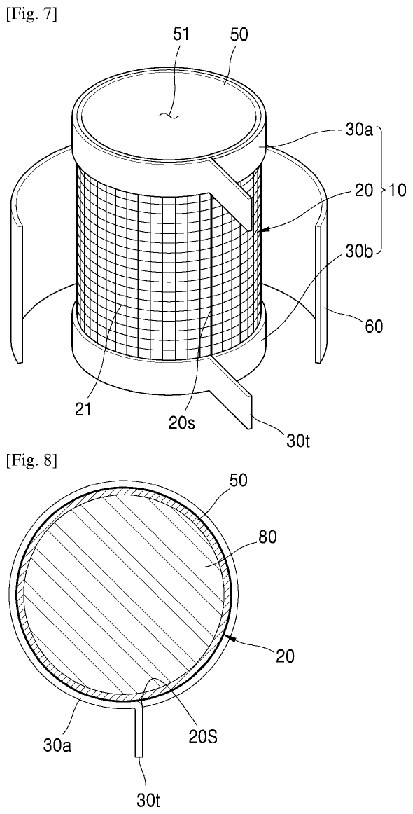

FIGS. 6 and 7 are schematic conceptual views of other operations of the method of manufacturing the heater assembly of the aerosol-generating apparatus, according to the embodiment of FIG. 4.

The heater assembly 10 according to the embodiments of FIGS. 6 and 7 includes a support 50 arranged on an inner side of the heating element 20. The support 50 may include a thermally conductive material such as iron, stainless steel, aluminum, copper, or ceramic and may be formed in a tubular shape.

The support 50 may be manufactured in a form corresponding to an exterior shape of an aerosol-generating article that is a heating target. Therefore, embodiments are not limited to the embodiment in which the support 50 and the heater assembly 10 are formed in a tubular shape, and shapes of the support 50 and the heater assembly 10 may vary to correspond to the exterior shape of the aerosol-generating article. The support 50 and the heater assembly 10 may each have a tubular shape including a cavity 51 for receiving an aerosol generating article 80 (e.g., cigarette). The support may have a polygonal cross-section such as a triangle or a square, or an oval cross-section.

In the process of arranging the support 50 inside the heating element 20, the support 50 having the tubular shape may be prepared first, and the heating element 20 may be bent to surround the support 50. Thus, the heating element 20 and the electrodes 30a and 30b may be arranged on an outer side of the support 50.

Alternatively, the support 50 having a tubular shape and the heater assembly 10 formed in a tubular shape with a diameter corresponding to the support 50 are separately prepared, and the support 50 may be inserted into the heater assembly 10.

The first electrode 30a of the heater assembly 10 at one end portion (i.e., upper portion) of the heating element 20 may extend in a circumferential direction of the heating element 20, forming a loop. The second electrode 30b of the heater assembly 10 at the other end portion (i.e., lower portion) of the heating element 20 may extend may extend in the circumferential direction, forming a loop. Hereinafter, the term “lengthwise direction” or “longitudinal direction” refers to a direction in which a longitudinal axis of the support 50 extends (i.e., a direction in which the aerosol generating article 80 is inserted into the cavity 51). Also, the term “length” refers to a dimension measured along the longitudinal direction.

FIGS. 6 and 7 illustrate that the electrodes 30a and 30b are arranged on both end portions of the heating element 20, but one or more embodiments are not limited to the arrangement of the electrodes 30a and 30b shown in FIGS. 6 and 7. For example, the electrodes 30a and 30b may be arranged to protrude further than the electrodes 30a and 30b in the lengthwise direction.

When the heater assembly 10 and the support 50 are coupled to each other, the first electrode 30a corresponds to an end portion 50a of the support 50 in the lengthwise direction, and the second electrode 30b corresponds to the opposite end portion 50b of the support 50 in the lengthwise direction.

FIG. 8 is a cross-sectional view of an example in which the heater assembly of the aerosol-generating apparatus of FIGS. 4 to 7 is used.

In a state in which the heater assembly 10 is coupled to the support 50, edges 20s of the end portions of the heating element 20 may contact each other.

In a general heater assembly manufactured by bending a heating element plate into a tubular shape, electrodes for supplying electricity to the heating element may be arranged apart from each other in the circumferential direction to prevent the short circuit. In this case, because a dead space exists between the electrodes in a circumferential direction, some portions of the aerosol-generating article may not be sufficiently heated.

However, in the structure of the heater assembly 10 according to an embodiment, the heating element 20 of the heater assembly 10 surrounds the entire circumference of the aerosol-generating article 80, and thus the side surface of the aerosol-generating article 80 may be uniformly heated along the circumferential direction. Accordingly, a high-quality aerosol may be generated from the aerosol-generating article 80.

FIGS. 6 and 7 illustrate that a length (i.e., height) of the heating element 20 is identical to that of the support 50, but one or more embodiments are not limited to the structure. For example, the length of the support 50 may be greater than that of the heating element 20 such that at least one of both end portions of the support 50 may protrude beyond the heating element 20. Alternatively, the length of the heating element 20 may be greater than that of the support 50.

After the heater assembly 10 is coupled to the support 50, a protective film 60 may be arranged on an outer side of the heater assembly 10. The protective film 60 may be arranged on an outer side of the heating element 20. The protective film 60 may perform a function of protecting the heating element 20, a heat insulation function of minimizing the transmission of heat generated by the heating element 20 to the outside, and an insulation function of preventing electricity leakage to other components. The protective film 60 may include, for example, a resin material such as polyimide, silicon, or Teflon. The protective film 60 may be manufactured in, for example, a tube form and then coupled to the heating element 20 having the tubular shape, or may be manufactured in a sheet form and then arranged to surround the outer side of the heating element 20 having the tubular shape.

The electrodes 30a and 30b of the heater assembly 10 may each have a terminal 30t at an end portion thereof. As shown in FIGS. 7 and 8, the terminals 30t may be drawn outwards from the heating element 20. Components for supplying external power may be connected to the terminals 30t.

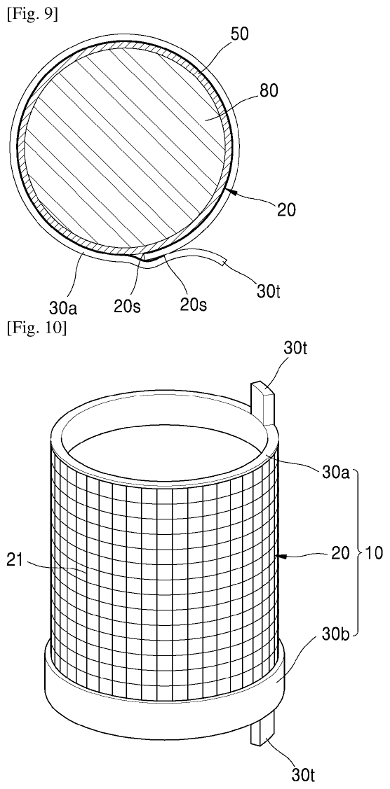

FIG. 9 is a cross-sectional view of a heater assembly of an aerosol-generating apparatus, according to another embodiment.

In the heater assembly of FIG. 9, the end portions of the first electrode 30a coupled to the outer side of the heating element 20 may overlap each other. Therefore, similarly to the heater assembly according to the embodiment of FIG. 8, the heating element 20 may completely surround the aerosol-generating article 80 in the circumferential direction of the aerosol-generating article 80 that is the heating target, and thus the aerosol-generating article 80 may be uniformly heated. Also, as the end portions of the first electrode 30a overlap each other, the coupling of the first electrode 30a to the heating element 20 may be stably maintained.

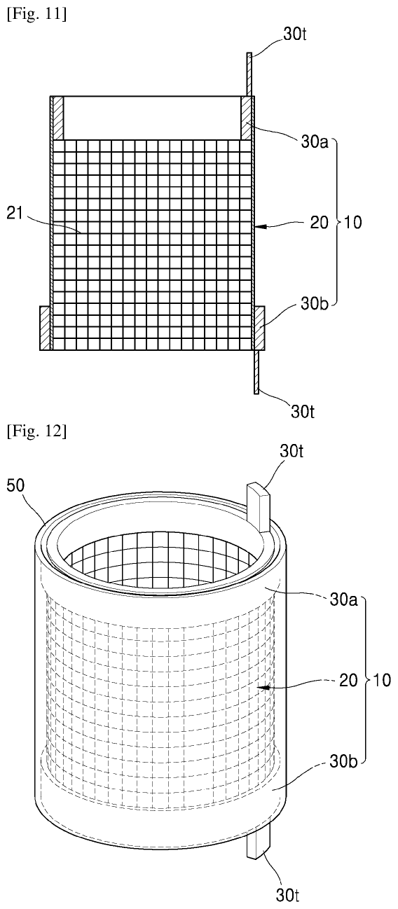

FIG. 10 is a perspective view of a heater assembly of an aerosol-generating apparatus, according to another embodiment. FIG. 11 is a cross-sectional view of the heater assembly of the aerosol-generating apparatus, according to the embodiment of FIG. 10.

The heater assembly 10 according to the embodiments of FIGS. 10 and 11 includes the heating element 20 which is formed in a mesh having a tubular shape The electrodes 30a and 30b for supplying electricity to the heating element 20 may be respectively arranged at the opposite end portions of the heating element 20, and extend along the circumferential direction.

The electrodes 30a and 30b include the first electrode 30a and the second electrode 30b. The first electrode 30a may be arranged on an inner side of the heating element 20, and the second electrode 30b may be arranged on the outer side of the heating element 20. Therefore, the first electrode 30a surrounds the entire end portion of the inner side of the heating element in the circumferential direction, and the second electrode 30b surrounds the entire end portion of the other side of the heating element 20.

The electrodes 30a and 30b of the heater assembly 10 each include the terminal 30t at the end portion thereof. In a state in which the electrodes 30a and 30b are coupled to the outer side of the heating element 20, the terminals 30t may be drawn outwards from the heating element 20. Components for supplying external power may be connected to the terminals 30t.

The support 50 may be arranged on the inner side of the heating element 20 in the heater assembly 10. However, one or more embodiments are not limited thereto, and the heater assembly 10 may not include the support 50.

When the heater assembly 10 only includes the heating element 20 without the support 50, the inner side of the heating element 20 directly faces the aerosol-generating article, thereby directly heating the aerosol-generating article. In this case, a protective film may be arranged on at least one of the inner side and the outer side of the heating element 20 to protect the heating element 20.

FIG. 12 is a perspective view of a heater assembly of an aerosol-generating apparatus, according to another embodiment.

The heater assembly 10 according to the embodiment of FIG. 12 includes a heating element 20 formed in a mesh having a tubular shape. The electrodes 30a and 30b for supplying electricity to the heating element 20 may be arranged at the opposite end portions of the heating element 20, and extend along a circumferential direction of the heating element 20. The support 50 having a tubular shape may be arranged on an outer side of the heating element 20.

Although not illustrated, a protective film for protecting the heating element 20 may be arranged on at least one of an inner side and an outer side of the heating element 20.

As shown in FIG. 12, the support 50 may be arranged on the outer side of the heating element 20 and thus may stably maintain a coupling structure in which the heating element 20 is coupled to the electrodes 30a and 30b.

Also, because an inner side of the support 50 surrounds the outer side of the heating element 20, heat may be maintained between the inner side of the support 50 and the outer side of the heating element 20. That is, because of heated air present in a space between the support 50 and the outer side of the heating element 20, a high-temperature environment may be generated around the heating element 20, and thus efficiency of heating may be improved.

Also, the support 50 may prevent the heat generated by the heating element 20 from radiating to the outside of the support 50. The support 50 may include a material having low thermal conductivity, for example, plastic or glass, to prevent the transmission of the heat to the outside of the support 50. Alternatively, the basic structure of the support 50 may be formed using a metal material, and a shielding layer for blocking the heat transmission may be arranged on at least one of the inner side and the outer side of the support 50. The shielding layer may include a shielding film arranged on at least one of the inner side and the outer side of the support 50, or heat transmission shielding paint that is spread on a surface of the support 50.

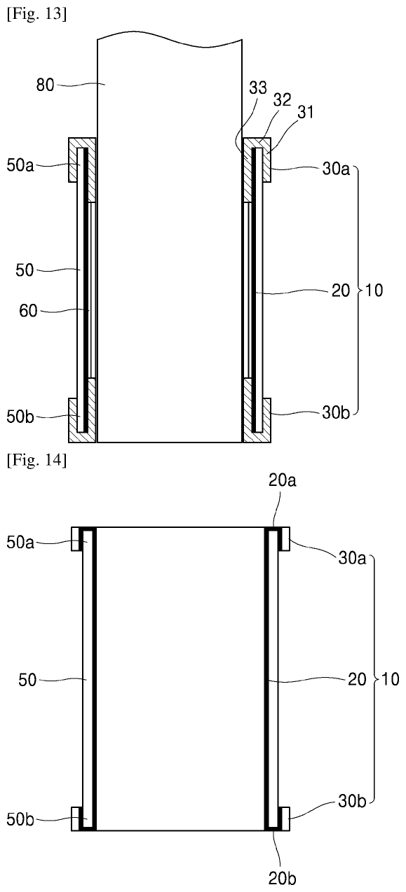

FIG. 13 is a cross-sectional view of a heater assembly of an aerosol-generating apparatus, according to another embodiment.

The heater assembly 10 according to the embodiment of FIG. 13 includes: a heating element 20, electrodes 30a and 30b, a heating element 20, a support 50, and a protective film 60. The heating element 20 may be formed in a mesh having a tubular shape. The electrodes 30a and 30b for supplying electricity to the heating element 20 may be respectively arranged at both end portions of the heating element 20 in the lengthwise direction, and extend in a circumferential direction of the heating element 20. The support 50 may be arranged on an outer side of the heating element 20, and the protective film 60 may cover an inner side of the heating element 20.

The electrodes 30a and 30b include the first electrode 30a arranged at the end portion of the support 50 in the lengthwise direction of the support 50 and the second electrode 30b arranged on the opposite end portion of the support 50 in the lengthwise direction of the support 50. An end portion 33 of each of the first and second electrodes 30a and 30b is connected to an inner side of the heating element 20, and the other end portion 31 of each of the first and second electrodes 30a and 30b contacts an outer side of the support 50. The end portion 33 and the other end portion 31 of each of the first and second electrodes 30a and 30b are connected to each other by a folded portion 32 that is folded along an edge of an end portion of the support 50. Therefore, as shown in FIG. 13, a vertical cross-sectional shape of each of the first and second electrodes 30a and 30b has a ‘U’ shape.

In the heater assembly 10 described above, the aerosol-generating article 80 that is the heating target is heated by the heating element 20 while the aerosol-generating article 80 is inserted into the heating element 20 of the heater assembly 10. Because the heat generated by the heating element 20 is directly transmitted to the aerosol-generating article 80 as the inner side of the heating element 20 faces the outer side of the aerosol-generating article 80, the aerosol-generating article 80 may be effectively heated.

Also, because the heating element 20 entirely surrounds a circumference of the aerosol-generating article 80, the aerosol-generating article 80 may be uniformly heated.

Also, because the heated air is kept in a lattice space of the mesh of the heating element 20, a high-temperature environment for heating the aerosol-generating article 80 may be created around an outer side surface of the aerosol-generating article 80.

Also, because the electrodes 30a and 30b coupled to both end portions of the heating element 20 are stably coupled to both edges of the support 50 arranged on the outer side of the heating element 20, a coupling structure in which the heating element 20, the electrodes 30a and 30b, and the support 50 are coupled may be firmly maintained.

FIG. 14 is a cross-sectional view of a heater assembly of an aerosol-generating apparatus, according to another embodiment.

The heater assembly 10 according to the embodiment of FIG. 14 includes a heating element 20 which is formed in a mesh having a tubular shape and generates heat when electricity is supplied, electrodes 30a and 30b which are respectively arranged at opposite end portions of the heating element 20 in the lengthwise direction and extend along a circumferential direction of the heating element 20, and a support 50 arranged on an outer side of the heating element 20.

Although not illustrated, a protective film may be arranged to cover at least one of the inner side and the outer side of the heating element 20.

Each of an end portion 20a and the other end 20b of the heating element 20 may be folded towards an outer side of the support 50 over both end portions of the support 50.

The electrodes 30a and 30b include a first electrode 30a and a second electrode 30b. The first electrode 30a is arranged on the end portion 20a of the heating element 20 that is positioned on an outer side of the support 50. Likewise, the second electrode 30b is arranged on the other end portion 20b of the heating element 20 that is positioned on an outer side of the support 50. Therefore, the first electrode 30a corresponds to one end region 50a of the support 50, and the second electrode 30b corresponds to the other end region 50b of the support 50.

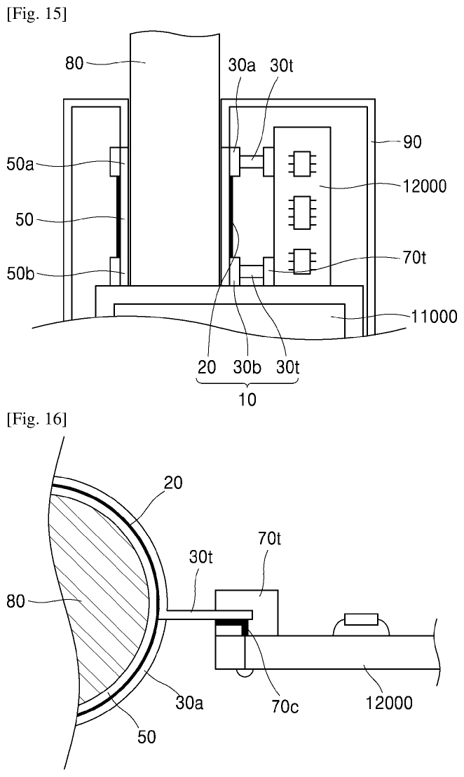

FIG. 15 is a schematic cross-sectional view of a portion of an aerosol-generating apparatus, according to another embodiment.

The aerosol-generating apparatus according to the embodiment of FIG. 15 includes: a heating element 20 formed in a mesh having the tubular shape in which the aerosol-generating article 80 may be accommodated; the heater assembly 10 including the electrodes 30a and 30b arranged at opposite end portions of the heating element 20 in a lengthwise direction of the heating element 20 and extending along a circumferential direction of the heating element 20; a support 50 arranged on an inner side of the heating element 20; and an electricity supply unit supplying electricity to the heater assembly 10.

The aerosol-generating apparatus includes a case 90 that accommodates and protects components such as the heater assembly 10, a battery 11000, and a controller 12000.

In a state in which the heater assembly 10 is coupled to the support 50, the first electrode 30a corresponds to the end region 50a of the support 50, and the second electrode 30b corresponds to the other region 50b of the support 50.

Because an internal diameter of the support 50 corresponds to an external diameter of the aerosol-generating article 80, the support 50 may stably support the aerosol-generating article 80. Also, the support 50 may transmit the heat, which is generated by the heating element 20, to the aerosol-generating article 80 and may perform a function of heating the aerosol-generating article 80.

The electricity supply unit may be any one of the battery 11000 and the controller 12000 or a combination thereof. For example, the battery 11000 may be directly connected to the heater assembly 10 or may be connected to the heater assembly 10 through the controller 12000. The controller 12000 may control the electricity supply to the heater assembly 10.

Referring to FIG. 15, the controller 12000 includes sockets 70t that may be connected to the terminals 30t of the heater assembly 10. As the terminals 30t of the heater assembly 10 are electrically connected to the sockets 70t of the controller 12000, the controller 12000 may control the electricity supplied to the heater assembly 10 from the battery 11000.

FIG. 16 is a schematic diagram illustrating a connection between a heater assembly and other components of an aerosol-generating apparatus according to an embodiment.

Referring to FIG. 16, the terminal 30t of the first electrode 30a of the heater assembly is electrically connected to a connector 70c of the socket 70t of the controller 12000. According to the structure above, the heater assembly may be connected to the controller 12000 in a simple manner that the terminal 30t of the first electrode 30a of the heater assembly is inserted into the socket 70t. Also, the connection between the heater assembly and the connector 70c may be stably maintained while the aerosol-generating apparatus is used.

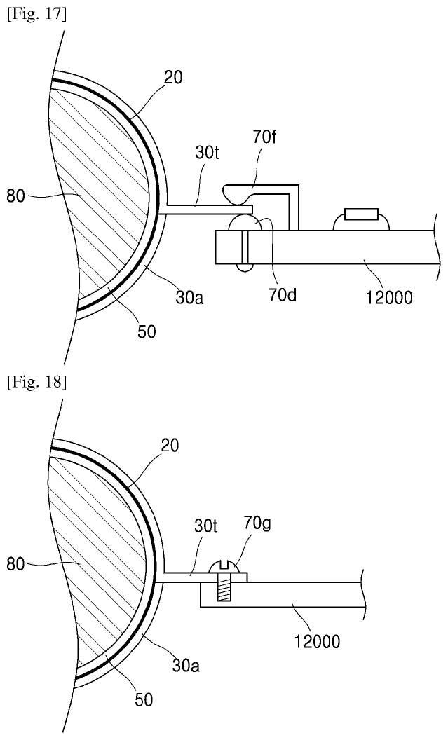

FIG. 17 is a schematic diagram illustrating a connection between the heater assembly and other components of an aerosol-generating apparatus according to another embodiment.

In the aerosol-generating apparatus according to the embodiment of FIG. 17, the controller 12000 includes a connector 70d and a pressure clip 70f that are electrically connected to the terminal 30t of the heater assembly. The pressure clip 70f may stably maintain a connection of the connector 70d to the terminal 30t by pressing the terminal 30t of the heater assembly in a direction towards the connector 70d.

One or more embodiments are not limited to the structures of the pressure clip 70f and the connector 70d, and the pressure clip 70f and the connector 70d may be variously changed. For example, the pressure clip 70f and the connector 70d may be changed to pogo pins using springs or pins having electrical conductivity.

FIG. 18 is a schematic diagram illustrating a connection between the heater assembly and other components of an aerosol-generating apparatus according to another embodiment.

In the aerosol-generating apparatus according to the embodiment of FIG. 18, the terminal 30t of the heater assembly may be electrically connected to a connection terminal of the controller 12000, and the terminal 30t of the heater assembly may be fixed to the controller 1200 by a coupling means 70g. The coupling means 70g is not limited to a bolt illustrated in FIG. 18 and may be changed to a rivet or a pin.

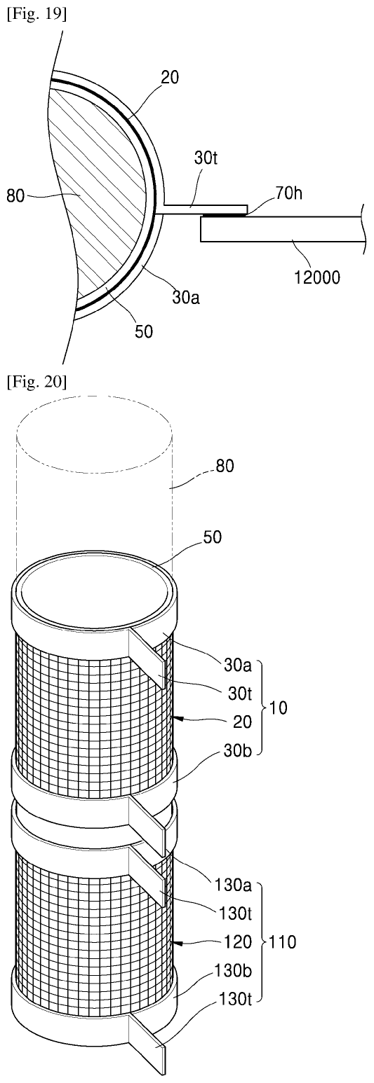

FIG. 19 is a schematic diagram illustrating a connection between the heater assembly and other components of an aerosol-generating apparatus according to another embodiment.

In the aerosol-generating apparatus according to the embodiment of FIG. 19, the connection terminal of the controller 12000 is electrically connected to the terminal 30t of the heater assembly by a soldering portion 70h. However, embodiments are not limited thereto. For example, the connection terminal of the controller 12000 may be electrically connected to the terminal 30t of the heater assembly by using an electrically conductive adhesive or welding.

FIG. 20 is a perspective view of a heater assembly of an aerosol-generating apparatus, according to another embodiment.

In the aerosol-generating apparatus according to the embodiment of FIG. 20, a plurality of heater assemblies 10 and 110 are sequentially arranged in the lengthwise direction (i.e., a direction in which the aerosol-generating article 80 extends). The aerosol-generating apparatus includes a support 50 having a tubular shape and extending in a lengthwise direction of the aerosol-generating article 80, a first heater assembly 10 arranged on one outer side of the support 50, and a second heater assembly 110 arranged on the other side of the support 50.

The first heater assembly 10 includes a heating element 20 surrounding an outer side of the support 50, electrodes 30a and 30b respectively surrounding opposite end portions of the heating element 20, and terminals 30t protruding from the end portions of the electrodes 30a and 30b.

The second heater assembly 110 includes a heating element 120 surrounding an outer side of the support 50, electrodes 130a and 130b respectively surrounding opposite end portions of the heating element 120, and terminals 130t protruding from the end portions of the electrodes 130a and 130b.

In the first heater assembly 10 and the second heater assembly 110, electricity may be separately supplied. For example, electricity may be only supplied to one of the first heater assembly 10 and the second heater assembly 110, or may be simultaneously supplied to both. Also, electricity having different values may be supplied to the first heater assembly 10 and the second heater assembly 110.

Alternatively, an electricity supply unit of the aerosol-generating apparatus may supply electricity to the first heater assembly 10 and the second heater assembly 110 according to different temperature profiles. The temperature profiles may include a relationship between a target temperature and a time taken to heat the aerosol-generating article 80 to the corresponding target temperature, or a relationship between the time taken to heat the aerosol-generating article 80 and electrical power required to be supplied to the first heater assembly 10 and the second heater assembly 110 to heat the aerosol-generating article 80 for the corresponding time.

In the aerosol-generating apparatus according to the one or more embodiments, portions of the aerosol-generating article 80 may be heated to different target temperatures by controlling the first heater assembly 10 and the second heater assembly 110 arranged in the lengthwise direction of the aerosol-generating article 80. Also, in the first heater assembly 10 and the second heater assembly 110, the heating elements 20 and 120 entirely surround the circumference of the aerosol-generating article 80. Therefore, the side surface of the aerosol-generating article 80 may be uniformly heated along the circumferential direction.

### INDUSTRIAL APPLICABILITY

One or more embodiments relate to a heater assembly having improved heating performance and an aerosol-generating apparatus including the same.

1. A heater assembly comprising:
a heating element formed in a mesh having a tubular shape, and configured to generate heat when electricity is supplied; and
a plurality of electrodes respectively connected to opposite end portions of the heating element in a lengthwise direction, extending in a circumferential direction of the heating element, and configured to supply the electricity to the heating element.

2. The heater assembly of claim 1, wherein
the plurality of electrodes comprise a first electrode arranged at an upper end portion of the heating element and a second electrode arranged at a lower end portion of the heater element, and
the first electrode and the second electrode extend along an entire circumference of the heating element.

3. The heater assembly of claim 2, wherein the first electrode is arranged on an inner side or an outer side of the heating element, and the second electrode is arranged on the inner side or the outer side of the heating element.

4. The heater assembly of claim 1, further comprising a support arranged on an inner side of the heating element and comprising a material that transmits heat.

5. The heater assembly of claim 1, further comprising a support arranged on an outer side of the heating element and comprising a material that blocks heat.

6. The heater assembly of claim 5, wherein
the plurality of electrodes comprise a first electrode arranged at an upper end portion of the heating element, and a second electrode arranged at a lower end portion of the heating element, and
the first electrode and the second electrode extend from an inner side of the heating element to an outer side of the support.

7. The heater assembly of claim 5, wherein
the heating element extends from an inner side of the support to an outer side of the support such that the opposite end portions of the heating element are arranged on the outer side of the support, and
the plurality of electrodes are respectively connected to the opposite end portions of the heating element arranged on the outer side of the support.

8. The heater assembly of claim 1, further comprising a protective film arranged on at least one of an inner side and an outer side of the heating element.

9. The heater assembly of claim 1, wherein opposite edges of the heating element in the circumferential direction contact each other.

10. The heater assembly of claim 1, wherein opposite end portions of the heating element in the circumferential direction overlap each other.

11. The heater assembly of claim 1, wherein the plurality of electrodes respectively comprise a plurality of terminals protruding outwards from the heating element.

12. An aerosol-generating apparatus comprising:
the heater assembly of claim 1; and
an electricity supply unit configured to supply electricity to the heater assembly,
wherein the heating element is configured to receive an aerosol-generating article in the lengthwise direction of the heating element.
